(19) United States
(12) Patent Application Publication
(10) Pub. No.: US 2011/0089009 A1
(43) Pub. Date: Apr. 21, 2011

(54) AIR CONDITIONER CONTROL MODULE

(76) Inventor: MING-TSUNG CHIU, Chung-Ho City (TW)

(21) Appl. No.: 12/581,954

(22) Filed: Oct. 20, 2009

(51) Int. Cl. H01H 13/76

(52) U.S. Cl. 200/5 A

(57) ABSTRACT

An air conditioner control module has a control panel and a circuit board mounted on a rear side of the control panel. The control panel has a plurality of buttons, a plurality of light holes, a display window and a dial. The control circuit is mounted on the circuit board and is connected with a plurality of micro switches, a plurality of indicators, a display device and a continuous variable resistor. The micro switches, indicators and display device respectively correspond to the buttons, light holes and display window. The continuous variable resistor is connected with the dial. The dial and the continuous variable resistor constitute a continuous dial fine-tuning temperature and humidity of an air conditioner and facilitating the operation of the air conditioner.

### BACKGROUND OF THE INVENTION

1. Field of the Invention

The present invention is related to an air conditioner control module, and more particularly to an air conditioner control module with fine tuning function.

2. Description of the Related Art

Regardless of private space or public occasion, air conditioners have become an indispensable commodity for all walks of life nowadays. Most current air conditioners come with remote control for users to control the functions of air conditioners. As air conditioners tend to be mounted at a higher place where could be out of reach to users, remote control has its irreplaceable role to become the major operation interface of air conditioners. The components of remote control associated with setup and adjustment of air conditioners contains nothing more than a display and multiple function buttons. For example, the setup of temperature or humidity relies on an up button (increment) and a down button (decrement) to discretely increase or decrease temperature readings respectively. Although using two independent buttons to respectively control temperature rise and temperature drop of air conditioners is functionally independent and straightforward, such benefit may not satisfy users accustomed to a fine-tuning control interface with a dial. In that sense, a feasible solution addressing a more user-friendly operation interface must be provided as an alternative to users.

### SUMMARY OF THE INVENTION

An objective of the present invention is to provide an air conditioner control module. The module employs a dial allowing users accustomed to continuous dial interface to adjust the temperature or humidity reading of an air conditioner. Since the operation is continuous, the operation is more user-friendly and accurate.

To achieve the foregoing objective, the air conditioner control module has a control panel, at least one continuous variable resistor and a circuit board.

The control panel has a plurality of openings, a plurality of buttons respectively mounted in the plurality of openings, a plurality of light holes, a display window and at least one dial.

The at least one continuous variable resistor is mounted on a rear side of the control panel.

The circuit board is mounted on a rear side of the control panel and has a control circuit, a plurality of micro switches, a plurality of indicators and a display device.

The control circuit is electronically connected with at least one continuous variable resistor. Each continuous variable resistor is connected to the corresponding dial on the control panel.

The plurality of micro switches respectively correspond to the buttons.

The plurality of indicators respectively correspond to the light holes.

The display device corresponds to the display window.

As the dial interface formed by combining the dial on the control panel and the continuous variable resistor on the circuit board can be adopted to setup and control of the temperature or humidity reading of an air conditioner, to users accustomed to continuous dial interfaces, the continuous dial interface is more user-friendly and convenient in operation.

### BRIEF DESCRIPTION OF THE DRAWINGS

FIG. 1 is an exploded perspective view of an air conditioner control module in accordance with the present invention; and

FIGS. 2A˜2G are a detailed circuit diagram of the air conditioner control module in accordance with the present invention.

### DETAILED DESCRIPTION OF THE INVENTION

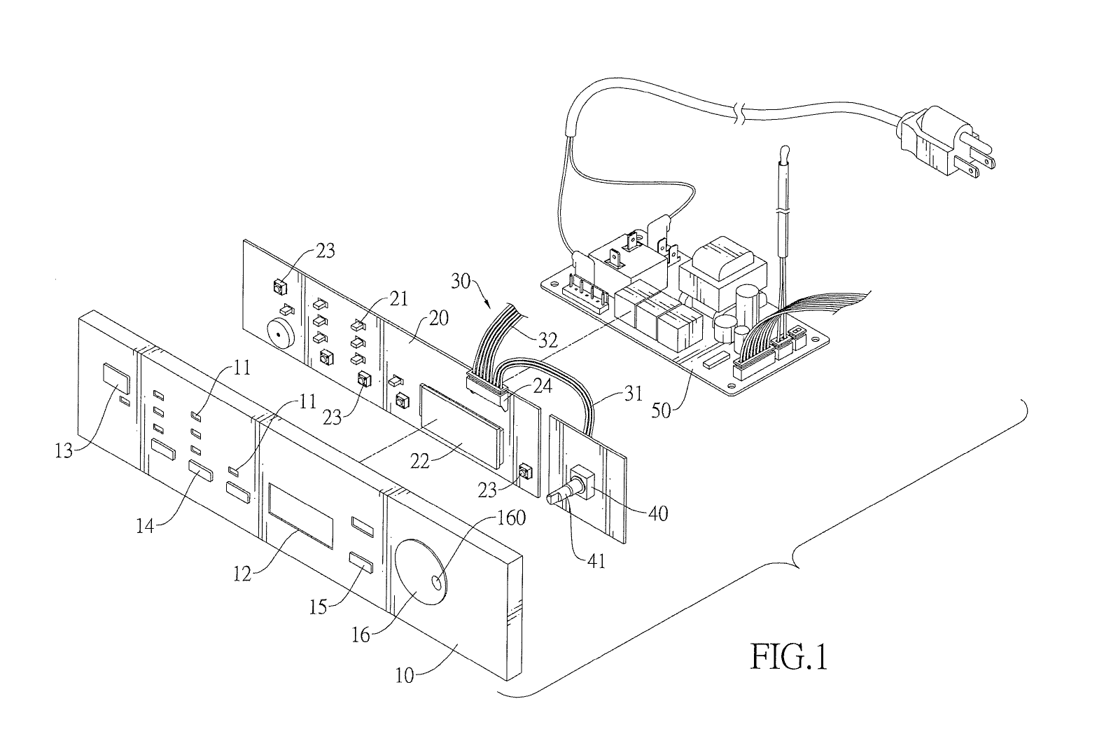

With reference to FIG. 1, an air conditioner control module has a control panel (10) and a circuit board (20).

The control panel (10) has a rectangular sheet body, a plurality of light holes (11), at least one display window (12), plurality of openings, a plurality of buttons (13 to 15) and a dial (16).

The light holes (11) and the at least one display window (12) are respectively formed on the body of the control panel (10), and are either hollowed out or covered with a transparent material. An arrangement of the light holes (11) and the at least one display window (12) on the body is changed according to different requirements. The openings are formed on the body. The buttons (13 to 15) are respectively mounted in the openings.

The dial (16) capable of pivotally rotating 360 degrees is mounted on the body of the control panel (10). The dial (16) has an outer surface relatively larger than that of regular dials. The dial (16) can be touched and turned to rotate 360 degrees. The dial (16) further has a dent (160) formed on the outer surface of the dial (16) and located near an edge of the outer surface. Therefore, the user's finger touches the dent (160) to conveniently rotates the dial (16) in operation since a location of the dent (160) is distant from a center of the dial (16).

The circuit board (20) is about the same size of the control panel (10) and is fixed on a rear side of the control panel (10). The circuit board has a control circuit (not shown, a feasible circuit solution thereof is described in details later), a plurality of indicators (21), a display device (22), a plurality of micro switches (23) and a flexible flat cable connector (24).

The control circuit is mounted on the circuit board (20). The plurality of indictors (21), the display device (22), the plurality of micro switches (23) and the flexible flat cable connector (24) are mounted on a surface of the control panel (10), and are electronically connected with the control circuit. The flexible flat cable connector (24) is further connected to a flexible flat cable (30). The flexible flat cable (30) has a plurality of terminals. One part of terminals (31) of the flexible flat cable (30) are connected to a continuous variable resistor (40). The other part of terminals (32) are connected to a control device (50) of an air conditioner.

When the circuit board (20) and the continuous variable resistor (40) are mounted to the rear side of the control panel (10), the indicators (21) respectively correspond to the light holes, the display device (22) corresponds to the display window, and the micro switches respectively (23) correspond to the buttons (13 to 15) on the control panel (10).

The indicators (21) emit light through the light holes on the control panel (10). A screen of the display device (22) is exposed through the display window (12). The micro switches (23) on the circuit board (20) are triggered by pressing the corresponding buttons (13 to 15) on the control panel (10).

Moreover, the continuous variable resistor (40) connected to the control circuit on the circuit board (20) is a dial capable of pivotally rotating 360 degrees, and has a pivot shaft (41) connected with the dial (16) on the control panel (10). When the dial (16) is rotated, it synchronously drives the pivot shaft (41) to rotate therewith, such that the continuous variable resistor (40) generates potential variation continuously. The dial (16) and the continuous variable resistor (40) are combined for users to fine-tune temperature and humidity of the air conditioner.

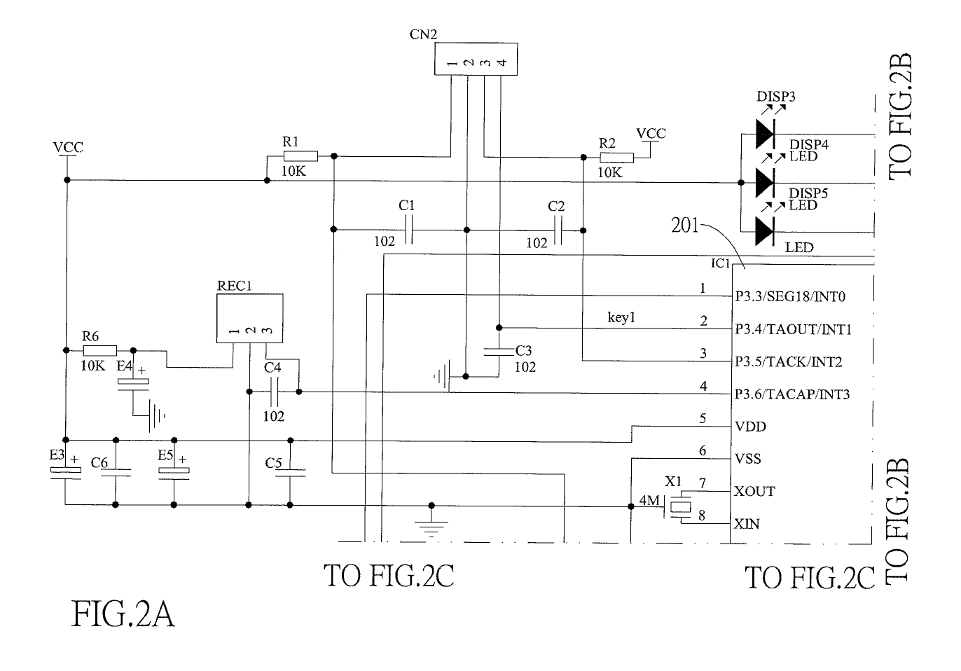

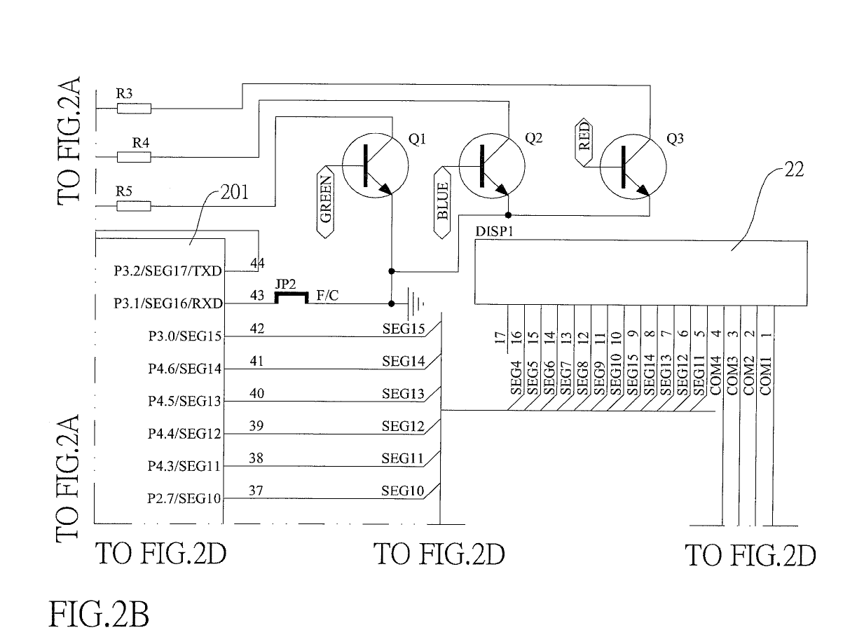

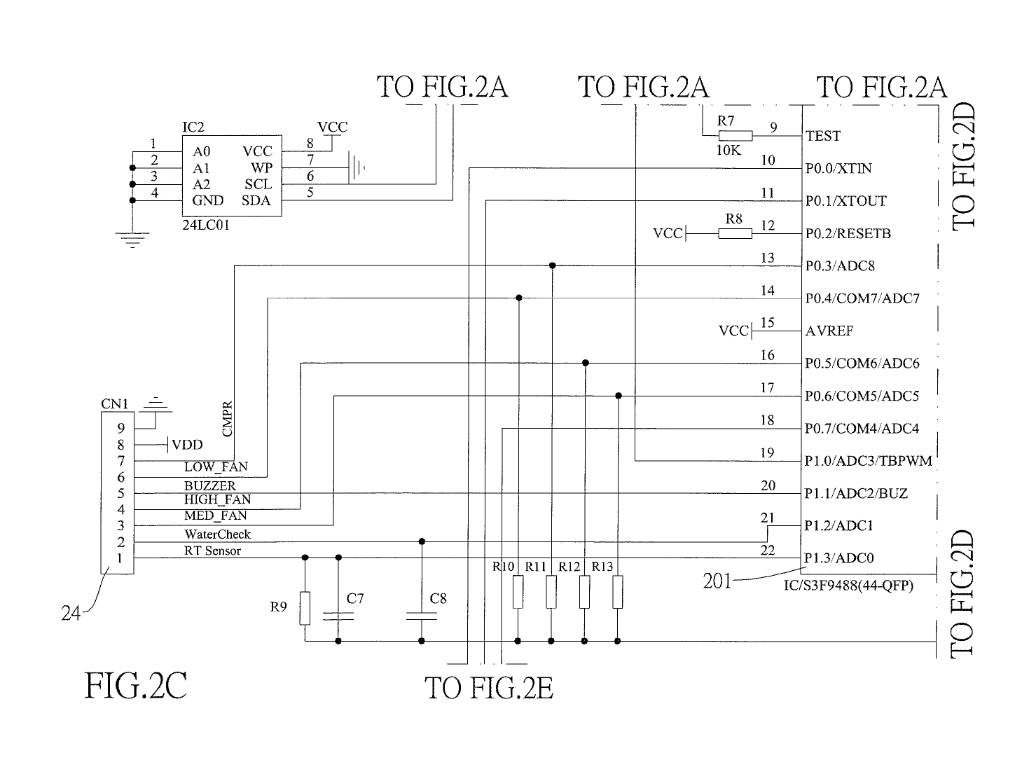

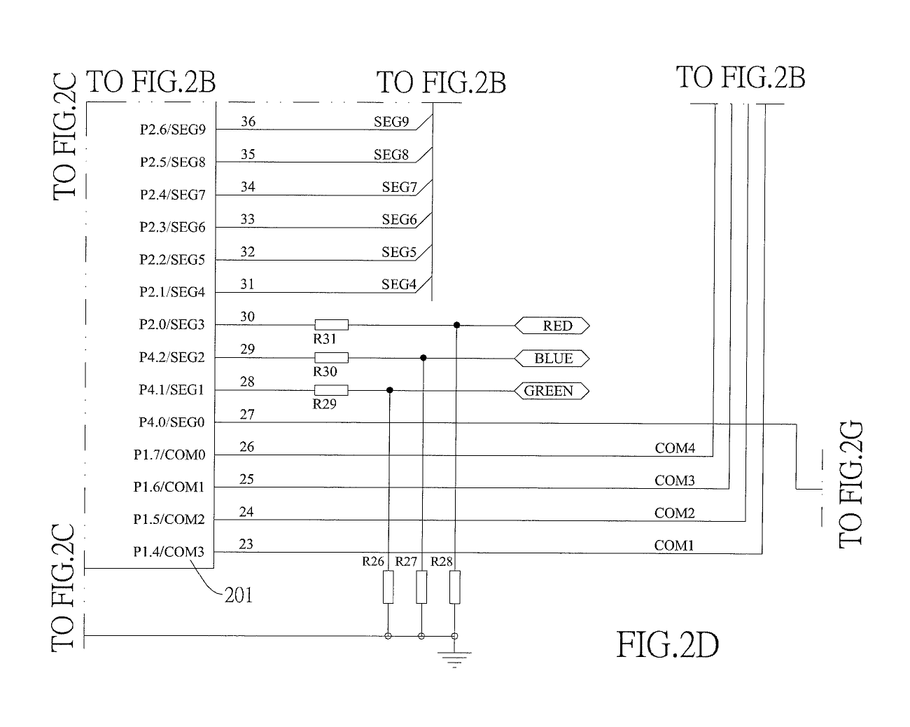

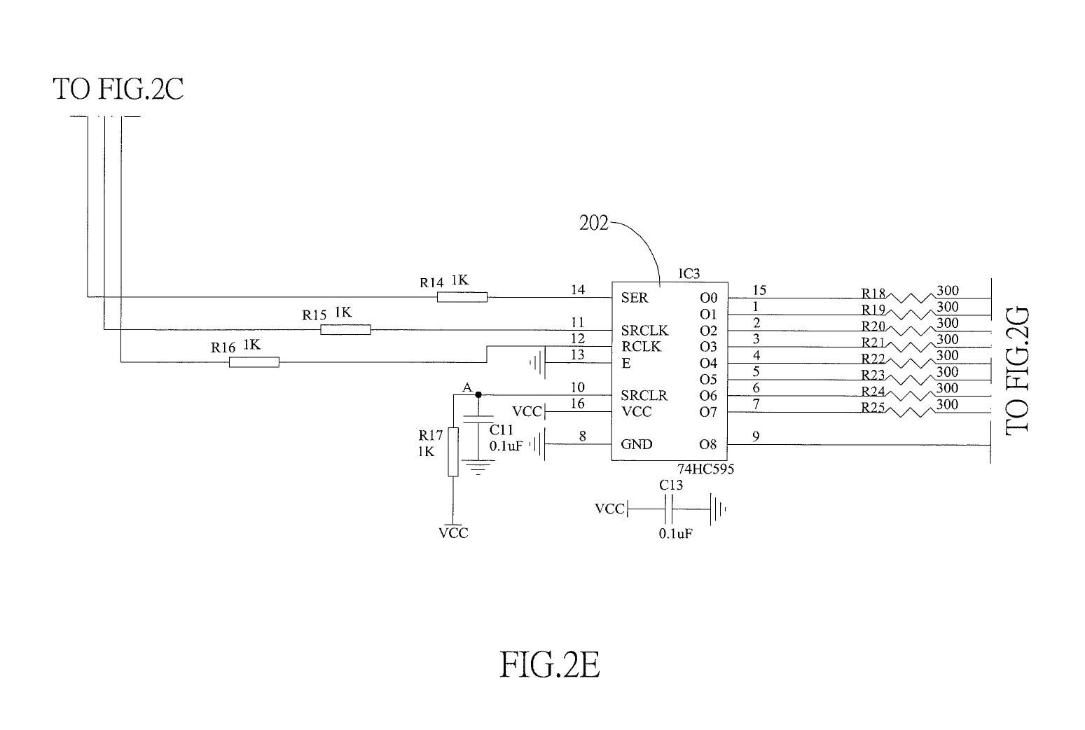

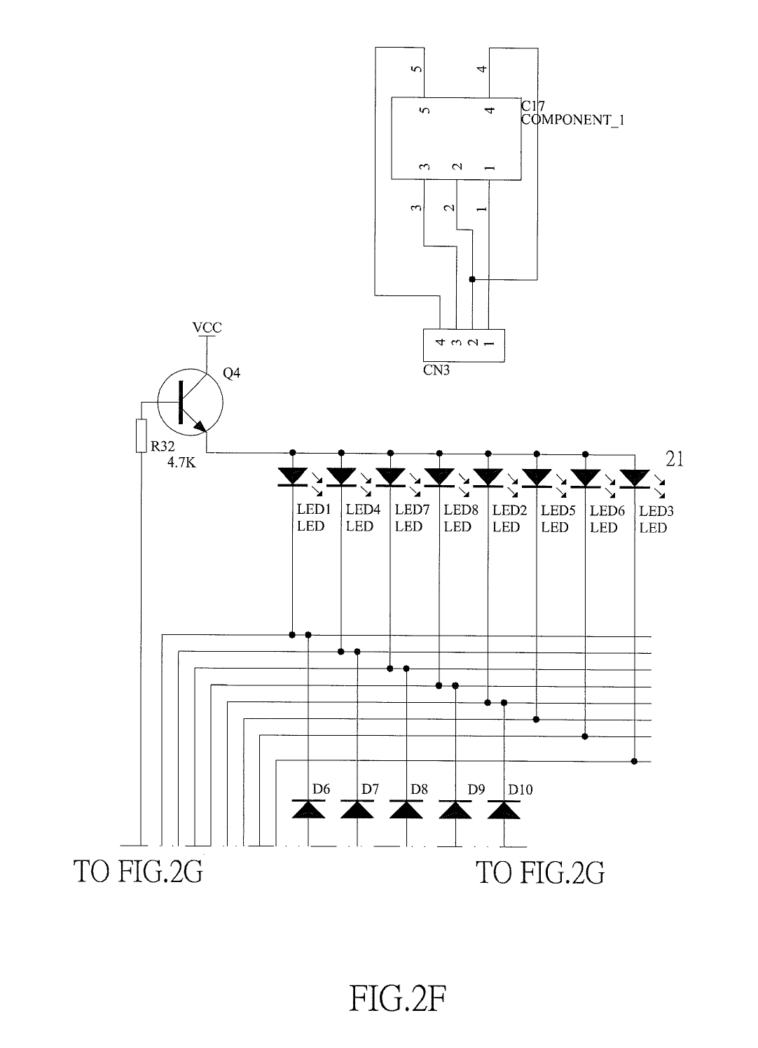

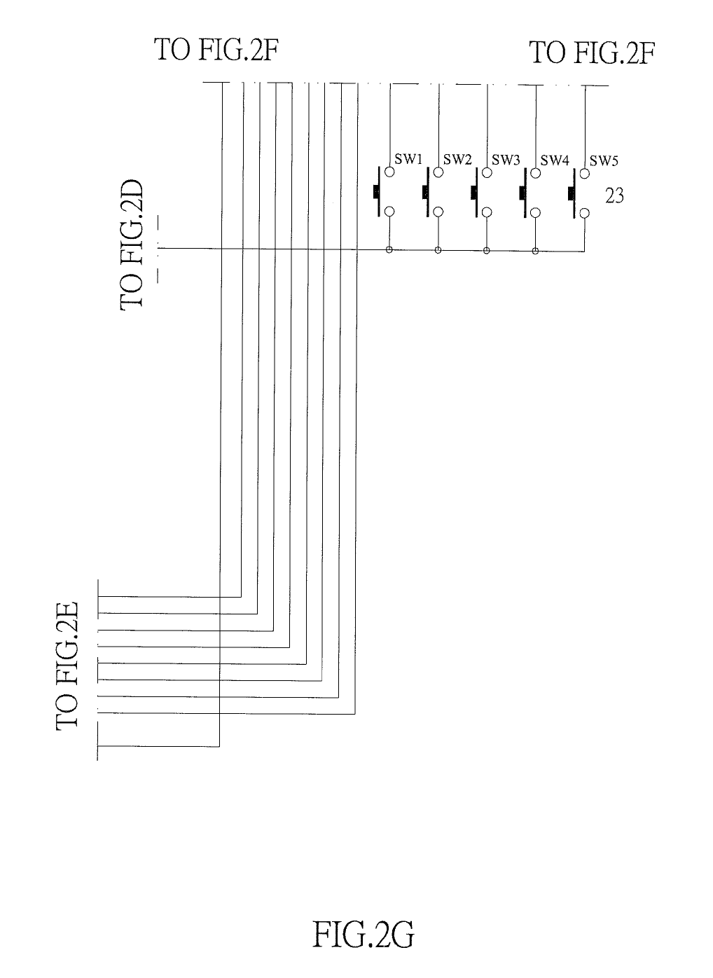

With reference to FIGS. 2A˜2G, a preferred embodiment of the control circuit on the circuit board (20) is shown. The control circuit has a microprocessor (201) and a shift register (202). The microprocessor (201) is electronically connected with the flexible flat cable connector (24) through a plurality of pins (13, 14, 16, 17, 20 to 22) and is further electronically connected with a control device of the air conditioner and the continuous variable resistor (both not shown) through the flexible flat cable (not shown) to send out control signals for adjusting temperature or humidity to the control device and receive potential variation from the continuous variable resistor.

The shift register (202) is electronically connected with part of IO pins (10, 11, 18) of the microprocessor (201) and multiple light-emitting diodes LED1 to LED8 and the micro switches (23) for receiving switching signals of the micro switches (23). The microprocessor (201) turns on or off the light-emitting diodes LED1 to LED8 based on these switching signals. The light-emitting diodes here are part of the indicators (21). A plurality of pins (31 to 42) of the microprocessor (201) are connected to the display device (22) through a bus to drive the display device (22).

The control circuit is collaborated with the buttons (13 to 15) and the dial (16) on the control panel and the continuous variable resistor (40) on the circuit board (20) to provide a user-friendly air conditioner operation interface.

When users touch any button (13) to (15) on the control panel (10), the button (13) to (15) triggers the corresponding micro switch (23) on the circuit board (20) to issue a control command for executing a designated function. After receiving the control command, the microprocessor (201) issues the corresponding control signal to the control device (50) of the air conditioner in completion of the execution of the designated function. Similarly, when users rotate the dial (16) on the control panel (10), the continuous variable resistor (40) generates the corresponding potential variation to the microprocessor (201). The microprocessor (201) converts the potential variation to a corresponding reading value and drives the display device (22) to display the reading value. At the time, the microprocessor outputs the control signal to the control device (50)). It is noted that the continuous variable resistor (40) performs fine-tuning adjustment and the microprocessor (201) memorizes the potential variation outputted from the continuous variable resistor (40). This means that a specific reading value of temperature or humidity is set up when the pivot shaft (41) of the continuous variable resistor (40) is rotated a certain degree clockwise or counter-clockwise. The reading value is displayed on the display device (22) and is memorized by the microprocessor (201). Regardless of if the continuous variable resistor (40) changes a control option of the air conditioner including temperature, humidity and the like, the microprocessor (201) always drives the display device (22) to display last reading value previously set up for the control option when the same control option is selected. For any subsequent setup of the control item, the microprocessor (201) can continuously increase or decrease the reading value of the control item with respect to the last reading wherever the last value of the control item measured from the continuous variable resistor is.

In sum, the air conditioner control module of the present invention adopts a fine-tuning dial for users to set up temperature or humidity reading of the air conditioner in a continuously dialing fashion, thereby providing a more user-friendly choice of the operation interface and making the operation more accurate and convenient.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An air conditioner control module, comprising:
a control panel having a plurality of openings, a plurality of buttons respectively mounted in the plurality of openings, a plurality of light holes, a display window and at least one dial;
at least one continuous variable resistor mounted on a rear side of the control panel; and
a circuit board mounted on a rear side of the control panel and having
a control circuit electronically connected with at least one continuous variable resistor, each continuous variable resistor connected to the corresponding dial on the control panel;
a plurality of micro switches respectively corresponding to the buttons;
a plurality of indicators respectively corresponding to the light holes; and
a display device corresponding to the display window.

2. The air conditioner control module adopting a dial as claimed in claim 1, wherein each continuous variable resistor has a pivot shaft connected with the corresponding dial on the control panel.

3. The air conditioner control module adopting a dial as claimed in claim 2, wherein the circuit board further comprises:
a flexible flat cable connector electronically connected with the control circuit; and
a flexible flat cable connected to the flexible flat cable connector and having two part of terminals, wherein one part of the terminals of the flexible flat cable are connected to the continuous variable resistor and the other part of the terminals adapted to connect with external devices.

4. The air conditioner control module adopting a dial as claimed in claim 3, wherein
the control panel has a rectangular sheet body;
the light holes and the display window are hollowed out or covered with a transparent material; and
a dent is formed on an outer surface of the dial and is located near an edge of the outer surface.

5. The air conditioner control module adopting a dial as claimed in claim 1, wherein a microprocessor has
a plurality of pins having
a first part of pins electronically connected to the at least one continuous variable resistor;
a second part of pins electronically connected to the indicators and the micro switches through a shift register; and
a third part of pins electronically connected to the display device through a bus to drive the display device.

6. The air conditioner control module adopting a dial as claimed in claim 2, wherein a microprocessor has
a plurality of pins having
a first part of pins electronically connected to the at least one continuous variable resistor;
a second part of pins electronically connected to the indicators and the micro switches through a shift register; and
a third part of pins electronically connected to the display device through a bus to drive the display device.

7. The air conditioner control module adopting a dial as claimed in claim 3, wherein a microprocessor has
a plurality of pins having
a first part of pins electronically connected to the at least one continuous variable resistor;
a second part of pins electronically connected to the indicators and the micro switches through a shift register; and
a third part of pins electronically connected to the display device through a bus to drive the display device.

8. The air conditioner control module adopting a dial as claimed in claim 4, wherein a microprocessor has
a plurality of pins having
a first part of pins electronically connected to the at least one continuous variable resistor;
a second part of pins electronically connected to the indicators and the micro switches through a shift register; and
a third part of pins electronically connected to the display device through a bus to drive the display device.
